(19) United States
(12) Patent Application Publication
(10) Pub. No.: US 2026/0344584 A1
(43) Pub. Date: Nov. 5, 2026

(54) GREENHOUSE SYSTEM

(71) Applicant: Ethan Hollins, Saint John, IN (US)

(72) Inventor: Ethan Hollins, Saint John, IN (US)

(21) Appl. No.: 19/665,500

(22) Filed: May 1, 2026

Related U.S. Application Data
(60) Provisional application No. 63/798,421, filed on May 1, 2025.

(51) Int. Cl. A01G 9/24; A01G 9/14

(52) U.S. Cl. CPC A01G 9/247; A01G 9/14; A01G 9/243; A01G 9/249

(57) ABSTRACT

Greenhouse systems including a greenhouse, a computer controller carried by the greenhouse, and one or more environmental sensors carried by the greenhouse for sensing parameters of the environment within the interior enclosure. The environmental sensors provide environmental data to the computer controller, and the computer controller processes the environmental data and delivers environmental information derived from the environmental data to a user and/or controls operation of one or more components carried by the greenhouse based on the environmental data. The greenhouse system is portable and/or modular to provide for easier installation and use in a wide variety of interior and/or urban environments. The greenhouse system preferably includes an automated irrigations system to water plants in the greenhouse, includes a rainwater collection system and/or solar panels to increase environmental sustainability, and implements AI technology to help monitor, operate, and/or maintain the greenhouse.

### CROSS-REFERENCE TO RELATED APPLICATIONS

This application claims priority to provisional U.S. Patent Application No. 63/798,421 filed May 1, 2025, the contents of which are incorporated herein by reference.

### BACKGROUND OF THE INVENTION

The invention generally relates to greenhouse systems and related methods.

Skyrocketing grocery prices and limited access to fresh, healthy food are uprooting the well-being of communities across the country. From 2020 to 2024, U.S. food prices rose by 23.6%, significantly impacting household budgets. On the other hand, families who grow their own vegetables and other edible plants can save up to 30% on grocery bills annually and benefit from nutritional (food) crops containing up to 20% more vitamins and minerals compared to conventionally grown produce. However, for people living in densely populated areas, such as urban areas, it is often difficult to grow enough vegetables or other edible plants to make any substantial impact on their budgets and/or diets due to a lack of suitable arable space. To overcome this, it may be possible to build a custom greenhouse in the limited space available to the average urban dweller that could provide improved yield per area. Unfortunately, due to higher mobility in today's culture, it can be expensive to have to build a new custom greenhouse every time a household changes their residence. Therefore, it would be desirable to have an improved greenhouse system for growing a wide variety of food crops that can be easily built within the space restrictions of the typical urban dwelling and/or can be easily modified and/or transported when a household moves to a new residence.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, greenhouse systems and methods for growing food crops.

According to a nonlimiting aspect, a greenhouse system includes a greenhouse, a computer controller carried by the greenhouse, and an environmental sensor carried by the greenhouse. The environmental sensor is operatively coupled with the computer controller to provide environmental data to the computer controller. The computer controller implements a software application that, when executed, processes the environmental data and delivers environmental information derived from the environmental data to a user and/or controls operation of one or more components carried by the greenhouse based on the environmental data.

Technical aspects of greenhouse systems as described above preferably include the ability for households in urban environments to more easily and/or effectively grow their own food crops, thereby saving money and/or providing access to more fresh foods.

These and other aspects, arrangements, features, and/or technical effects will become apparent upon detailed inspection of the figures and the following description.

### BRIEF DESCRIPTION OF THE DRAWINGS

FIG. 1 is a perspective view of a greenhouse system according to a nonlimiting embodiment of the invention.

FIGS. 2 and 3 are perspective views of greenhouse systems according to other nonlimiting embodiments of the invention.

FIGS. 4A and 4B are, respectively, front and rear perspective views of a modified version of the greenhouse system of FIG. 1.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated and encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the greenhouse system during its use and/or as represented in the drawings. All such relative terms are useful to describe the illustrated embodiment(s) but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

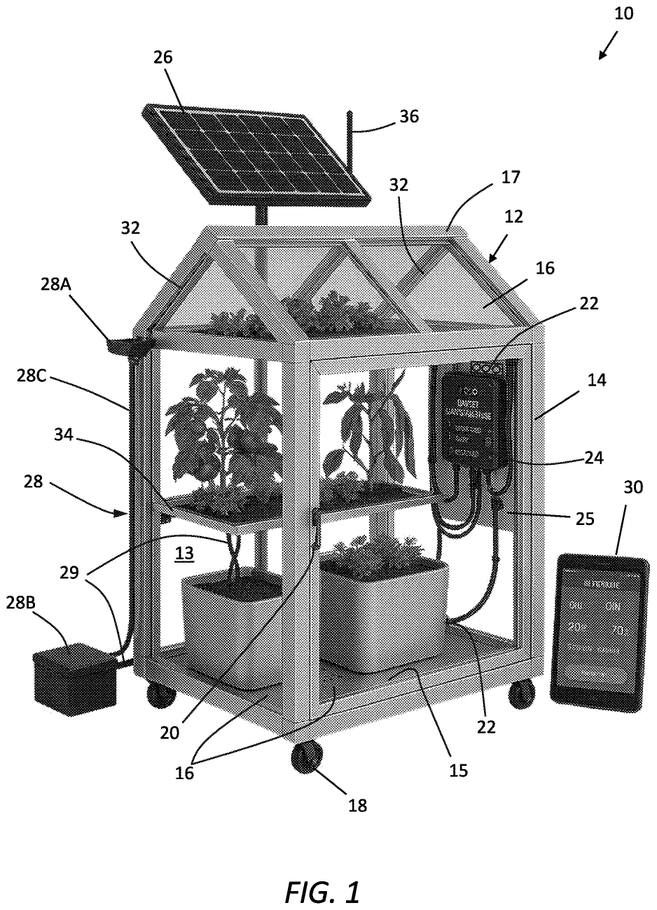

Turning now to the nonlimiting embodiments represented in the drawings, FIG. 1 depicts a portable greenhouse system 10 exemplifying certain nonlimiting aspects of the present invention. Preferred embodiments of the greenhouse system 10 provide a climate control, technology-enhanced, modular, and/or portable greenhouse system specially adapted for the limited space restrictions of modern urban living. Preferred embodiments of the greenhouse system 10 also provide for sustainable water and energy use by implementing a combination of low power sensors, rainwater reservoirs, optional solar-assisted power modules, moisture efficient soil systems, and data driven watering recommendations that prevent overuse.

The greenhouse system 10 includes a greenhouse 12 and various additional physical components that are carried by the greenhouse 12 and/or computer-implemented control and/or monitoring systems associated with and operationally coupled with the greenhouse 12. The greenhouse 12 includes a frame 14 that carries a floor 15, side walls 16, and a roof 17 through which sunlight can easily penetrate that together define an interior enclosure 13 in which an environment is maintained so that plants can be grown. The frame 14 may be made of any suitable material, such as lightweight, rust-resistant aluminum, other metals, wood, etc. In this example, the frame 14 has a rectangular floor frame, four vertical corner colums, a rectangualar top frame, and an A-frame roof frame; however, other frame shapes can be implemented. Aside from the frame 14, the side walls 16 and roof 17 of the greenhouse 12 are preferably formed by transparent and/or translucent panels to provide maximum ingress of sunlight into the interior enclosure 13. As a nonlimiting example, the panels of the side walls 16 and roof 17 may be formed of glass or plexiglass panes, or formed of transparent polycarbonate panels for enhanced durability and light transmission. The greenhouse 12 may also include a set of wheels 18 on the bottom of the frame 14 to provide for easy movement of the greenhouse. In the embodiment shown in FIG. 1, the wheels 18 are casters. The floor 15 of the greenhouse 12 may be made of opaque material, such as metal and/or wood. At least one of the side walls 16 and/or roof 17 of the greenhouse 12 includes and/or defines a door that can be opened and closed for accessing the interior enclosure 13, tend to plants and/or other components located in the interior enclosure 13, and/or deposit and remove plants from the interior enclosure 13. One or more handles 20 may be attached to the frame 14 and/or side walls 16 for easily maneuvering the greenhouse 12.

Various environmental sensors 22 are carried by the greenhouse 12 that sense parameters of the environment within the interior enclosure 13 to generate environmental data that can be used to monitor and/or tend crops in the greenhouse 12. In some embodiments, real time guidance is delivered through a suite of environmental sensors 22 that is integrated into the greenhouse 12. In preferred embodiments, parameters of the environment sensed by the environmental sensors 22 include soil moisture, air temperature, air humidity, and light, and the sensors 22 include one or more soil moisture sensors, temperature sensors, humidity sensors, and/or light sensors carried by the greenhouse 12. The environmental sensors 22 may be configured to continuously feed their respective environmental data live to an onboard computer controller 24 and/or to a remote software application (“remote app”), such as a monitoring and control app on a remote computer or mobile computing platform (e.g., a smart mobile telephone). The environmental sensors 22 make it possible for the greenhouse system 10 and an AI virtual assistant described hereinafter to provide immediate, context specific plant care recommendations that may help users improve crop yields.

The onboard controller 24 is a computer system that is integrated with/carried by the greenhouse 12. In this example, the onboard controller 24 is disposed on a support panel 25 carried by the frame 14 adjacent one of the side walls 16, although other locations could be used. The onboard controller 24 may include any suitable configuration of electronic computer hardware and software to implement the integrated app and various functionalities described herein. For example, the onboard controller 24 preferably includes a central processing unit, physical memory storage, power control circuitry, input/output devices, and/or data transmission/receiving circuitry.

An integrated computer-implemented application (“integrated app”) is executed by the onboard controller 24 to track environmental conditions from data received from the environmental sensor 22, control various other onboard components, and/or provides information to the user. The onboard controller 24, when executing the integrated app, is configured to provide monitoring of the various sensors 22 and monitor and control other systems carried by the greenhouse 12. In addition, the onboard controller 24 is configured to communicate with a remote computer-implemented software application that provides monitoring and/or control functionalities to a user remote from the greenhouse 12. For example, the onboard controller 24 preferably includes a data communications system, such as a wired or wireless data transceiver (e.g., a Wi-Fi, Bluetooth, and/or wired or wireless telephone transceiver), to provide data connectivity with a software platform application located on one or more remote computer systems 30, such as a remote personal computer, mobile computer (e.g., tablet or smart phone), and/or server.

The onboard controller 24 preferably includes a sensor hub configured to collect the data from the environmental sensors 22 and transmit the date to the integrated app executed by the onboard controller 24. The sensor hub preferably includes a wireless sensor hub and the environmental sensors 22 preferably includes corresponding wireless data transmitters to minimize wiring harnesses in the greenhouse 12. The integrated app run by the onboard controller 24 may further transmit the information obtained from the environmental sensors 22 as well as other system information to the remote app. The integrated app can thereby transmit the collected environmental data to the remote app. In this way, a user can remotely monitor information collected by environmental sensors 22, for example, to view real time conditions, receive alerts, and/or track plant health from any location. The integrated app may be configured to provide a subscription ecosystem.

One or more solar panels 26 are carried by the greenhouse 12 to generate renewable electrical energy to power the various electrical loads of the components carried by the greenhouse 12, such as the onboard controller 24, the environmental sensors 22, and other various actuators and/or onboard electronics. The solar panels 26 are preferably capable of being utilized to decrease outside power usage and increase the overall environmental sustainability of the greenhouse system 10.

The greenhouse system 10 preferably includes an optional rainwater harvesting system 28 to reduce water usage and increase its environmental sustainability. The rainwater harvesting system 28 includes one or more collectors 28A attached to the exterior of the frame 14 to collect rainwater runoff from the roof 17, a reservoir 28B to receive water collected by the collectors 28A, conduits 28C to channel rainwater from the collector(s) 28A to the reservoir 28B, and optionally one or more valves for controlling flow of water from the collectors 28A to the reservoir 28B. The collectors 28A may include one or more gutters attached along the edges of the roof 17. The collectors 28A are preferably modular attachments that can be attached to the frame 14 in predefined locations. The reservoir 28B is preferably connected to an automated watering system described hereinafter to allow the greenhouse 12 to use/reuse natural water sources efficiently.

The greenhouse system 10 preferably includes an automated watering system to provide for automated care of the plants. The automated watering system includes plumbing 29 that connects the reservoir 28B of the rainwater harvesting system 28 to planters within the greenhouse 12 and between planters within the greenhouse 12. The automated watering system further includes automated watering valves, as well as any necessary pumps and distribution nozzles to deliver water to the planters and optionally directly onto the plants inside the greenhouse 12. The automated water system may also be coupled to any suitable water supply, such as a residential water supply. The automated watering valves and any pumps are controlled by the integrated app. For example, in response to data received from the environmental sensors 22 relevant to soil moisture levels within the planters and/or other environmental alert systems, the integrated app may be configured to activate the automated watering system by activating (e.g., opening) and/or deactivating (e.g., closing) the watering valves. These components respond directly to parameter readings from the environmental sensors 22 to automatically deliver water to the food crops and/or provide notifications to the user when manual intervention is needed. In some configurations, the automated watering system may include hydroponic configurations.

LED grow lights 32 may be carried by the greenhouse 12 to provide an additional source of light nutrients for plants inside the greenhouse 12. The LED grow lights 32 may be powered from a battery system coupled to the solar panels 26 and/or may be powered from typical residential AC power. The LED grow lights 32 may be controlled by the integrated app automatically and/or may be manually controlled by a user, for example via the integrated app and/or the remote app.

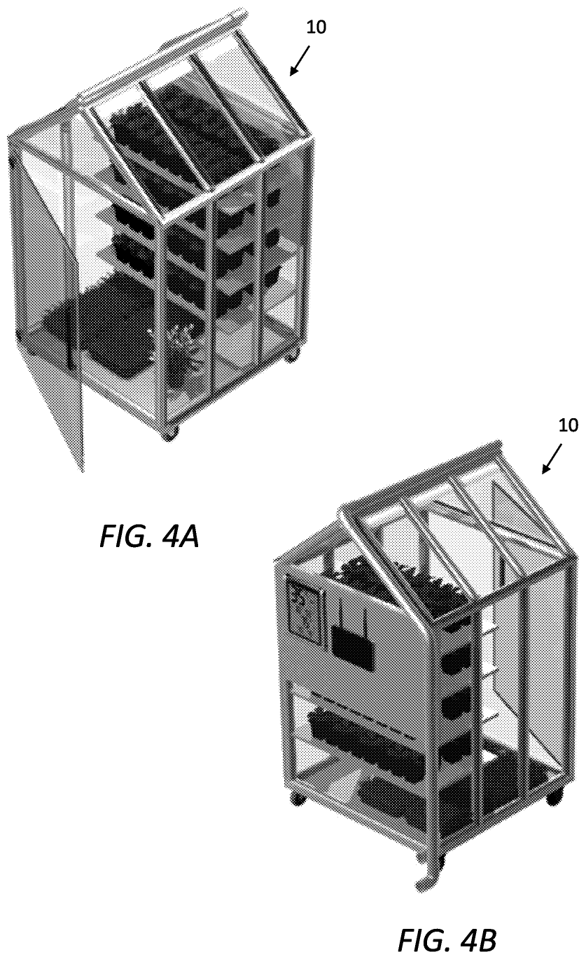

The greenhouse 12 preferably utilizes modular shelving 34 within the interior enclosure 13 of the greenhouse 12. The modular shelving 34 can preferably be arranged in multiple different pre-selected configurations and arrangements (FIGS. 4A and 4B) without having to physically modify the shelving 34 and/or the basic structure of the greenhouse 12. The modular shelving 34 thereby makes it possible for the greenhouse system 10 to provide different shelving layouts to accommodate use with wide varieties and sizes of plants and/or spaces.

One or more weather sensors 36 can be provided to assist the onboard controller 24 with maintaining a desirable environment within the enclosure 13. For example, the onboard controller 24 and/or integrated app can be configured to track rainwater levels and provide alerts for manual water addition during drought conditions sensed by the weather sensors 36.

The greenhouse system 10 may be further configured to promote urban gardening potential through features such as automated window slats, height adjustment for taller food crops, Wi-Fi integration for remote monitoring and control, and/or a cistern technology incorporated into the rainwater harvesting system 28.

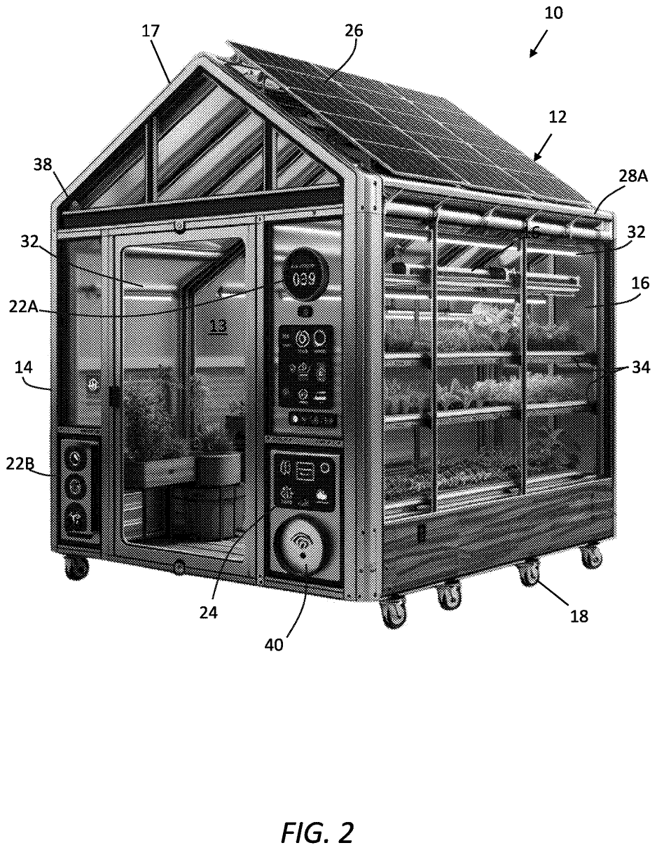

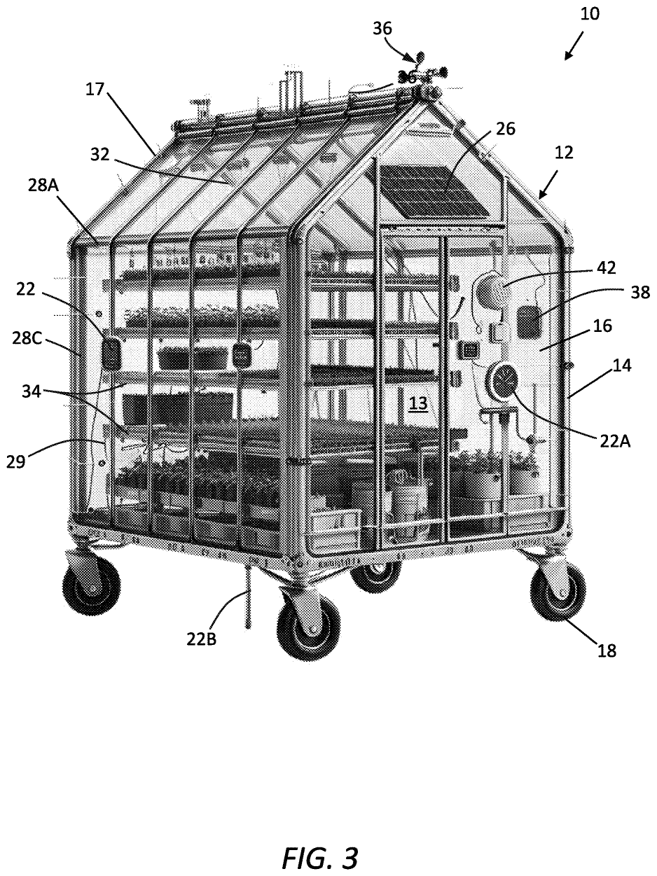

As evident from FIGS. 2 and 3, the greenhouse system 10 may be provided in different sizes to accommodate different space limitations. For example, the greenhouse system 10 may be provided in three sizes, extra small, small, and medium, to cater to various urban gardening space restrictions. For example, the greenhouse 12 of FIG. 1 may have outer dimensions of 2.5 ft×2.5 ft×4 ft (76 cm×76 cm×122 cm), which allows the greenhouse 12 to fit within apartments, patios, classrooms, and/or other small spaces while still supporting full environmental monitoring and control.

In view of similarities between the embodiments of FIGS. 1, 2, and 3, the following discussion of FIGS. 2 and 3 will focus primarily on aspects of the embodiments of FIGS. 2 and 3 that differ from the embodiment of FIG. 1 in some notable or significant manner. Other aspects of the embodiments of FIGS. 2 and 3 not discussed in any detail can be, in terms of structure, function, materials, etc., essentially as was described for the embodiment of FIG. 1.

FIG. 2 represents a configuration for the greenhouse 12 that can be larger than that of FIG. 1, represents the environmental sensors 22 as including a temperature gauge 22A and a moisture gauge 22B, a time lapse camera 38 for monitoring the plants within the greenhouse 12, and a Wi-Fi and Bluetooth connector 40.

FIG. 3 represents a configuration for the greenhouse 12 that can be smaller than that of FIG. 1, represents the environmental sensors 22 as including a temperature gauge 22A and a moisture gauge 22B, a time lapse camera 38 for monitoring the plants within the greenhouse 12, and a ventilator 42 controlled by the onboard controller (not shown) for assisting with controlling the environment within the enclosure 13.

The embodiments of the greenhouse systems 10 represented in FIGS. 1 through 3 preferably incorporate artificial intelligence (“AI”) technology to help monitor, operate, and/or maintain the greenhouse 12 and its components. The AI technology may be executed directly by the onboard controller 24, on a remote app, and/or through a remote server. In one embodiment, the AI technology is embedded through IRIS™, an interactive plant-care AI virtual assistant available through the integrated app and/or another computer software platform implemented on a suitable computer system, such as a personal computer, server, and/or mobile computer. The AI virtual assistant may be configured to analyze sensor data obtained from the environmental sensors 22, identify plant species, predict growth patterns, utilize the time lapse cameras 38, and/or detect potential growing problems early. The AI virtual assistant may be configured to provide step-by-step care instructions. The AI virtual assistant is preferably configured to adapt over time to user behavior and/or plant history, for example, to offer increasingly personalized guidance based on accumulated information acquired during operation of the greenhouse system. In some embodiments, other AI-driven monitoring, operation, maintenance, and/or educational modules may be incorporated.

The greenhouse systems 10 may include a learning management system (LMS) integration. For example, the software platform application may be configured to provide educational curricula usable by teachers and/or students to learn more about science and/or technology of growing plants and/or operating greenhouses. The LMS may be integrated directly into the software platform application and/or the software platform application may access a third-party LMS platform.

The greenhouse systems 10 are preferably compact, portable, and modular, making it possible to easily customize the systems 10 to the space and/or technology availabilities and restrictions of a particular user and/or location. The greenhouse systems 10 are preferably modular as a result of components of the greenhouse 12, as examples, the side walls 16, roof 17, environmental sensors 22, automated watering system, lighting 32, and rainwater harvesting system 28, are capable of being independently added, removed, or upgraded. This allows users to begin with a basic setup and expand functionality over time without replacing the entire system 10. This also allows users to begin with a basic setup and expand functionality over time without replacing the entire system.

Advantages of the greenhouse systems 10 preferably include the ability to minimize or reduce resource consumption and maximize plant health. The greenhouse systems 10 is also preferably capable of enhancing the sustainability and functionality of the greenhouse 12, making it ideal for urban dwellers seeking to grow organic and healthy produce. The greenhouse systems 10 can empower families to create sustainable gardens in urban areas, such as on balconies, terraces, rooftops, and/or limited-space backyards, to combat increased grocery prices and/or provide easier access to fresh fruits, grains, vegetables, tubers, and/or other food crops. These greenhouse systems 10 preferably enable a household to easily move and relocate the greenhouse systems 10 to new residences, thereby enabling the household to go anywhere and be able to have an effective greenhouse without having to purchase a new custom-built greenhouse. The greenhouse systems 10 disclosed herein thereby make it possible for urban residents (and others) to take control of their food sources and/or grow their own food crops year-round. This may also have the secondary benefits of promoting health and environmental sustainability wherever people live.

As previously noted above, though the foregoing detailed description describes certain aspects of one or more particular embodiments of the invention, alternatives could be adopted by one skilled in the art. For example, the greenhouse systems 10 and their components could differ in appearance and construction from the embodiments described herein and shown in the drawings, functions of certain components of the greenhouse systems 10 could be performed by components of different construction but capable of a similar (though not necessarily equivalent) function, and various materials could be used in the fabrication of the greenhouse systems 10 and/or their components. As such, and again as was previously noted, it should be understood that the invention is not necessarily limited to any particular embodiment described herein or illustrated in the drawings.

1. A greenhouse system for growing food crops, the greenhouse system comprising:
a greenhouse having a frame and a floor, walls, and roof that together define an interior enclosure of the greenhouse in which an environment is maintained for growing the food crops;
a computer controller carried by the greenhouse; and
environmental sensors carried by the greenhouse for sensing parameters of the environment within the interior enclosure and generating environmental data that can be used to monitor and/or tend crops in the greenhouse, the environmental sensors being operatively coupled with the computer controller to provide the environmental data to the computer controller;
wherein the computer controller implements a software application that, when executed, processes the environmental data and delivers environmental information derived from the environmental data to a user and/or controls operation of one or more components carried by the greenhouse based on the environmental data.

2. The greenhouse system of claim 1, wherein the computer controller provides real-time guidance to a user in response to the environmental data.

3. The greenhouse system of claim 1, wherein the greenhouse is portable.

4. The greenhouse system of claim 1, wherein the greenhouse and the components are modular.

5. The greenhouse system of claim 1, further comprising a solar panel carried by the greenhouse and configured to power electrical loads associated with the greenhouse.

6. The greenhouse system of claim 1, further comprising an automated watering system carried by the greenhouse and controlled by the computer controller to automatically deliver water to the food crops in response to the environmental data.

7. The greenhouse system of claim 6, further comprising a rainwater harvesting system carried by the greenhouse and operatively configured to provide water to the automated watering system.

8. The greenhouse system of claim 1, wherein the computer controller implements artificial intelligence technology to analyze growing conditions in response to the environmental data.

9. The greenhouse system of claim 1, wherein the computer controller delivers the environmental information to a remote computer for remote monitoring by a user.

10. The greenhouse system of claim 1, wherein the greenhouse software application includes a learning management system integration.

11. The greenhouse system of claim 1, further comprising an LED grow light carried by the greenhouse.

12. The greenhouse system of claim 1, wherein the parameters of the environment sensed by the environmental sensors include soil moisture, air temperature, air humidity, and light.

13. The greenhouse system of claim 1, wherein the food crops comprise vegetables, fruits, tubers, and/or grains.
